(19) United States
(12) Patent Application Publication
(10) Pub. No.: US 2014/0086009 A1
(43) Pub. Date: Mar. 27, 2014

(54) Methods and Apparatus for Waveform Processing

(71) Applicant: SCHLUMBERGER TECHNOLOGY CORPORATION, Sugar Land, TX (US)

(72) Inventor: Shinji Yoneshima, Sagamihara-Shi (JP)

(73) Assignee: Schlumberger Technology Corporation, Sugar Land, TX (US)

(21) Appl. No.: 13/623,875

(22) Filed: Sep. 21, 2012

(51) Int. Cl. G01V 1/50

(52) U.S. Cl. 367/31

(57) ABSTRACT

Methods and apparatus for waveform processing are disclosed. An example method includes estimating a theoretical value of a first input parameter and setting a second input parameter to a known value. The known value is different than an actual value of the second input parameter. The method also includes identifying a frequency band using a processor that minimizes an effect of the second input parameter on a shear slowness inversion value.

### BACKGROUND

Sonic logging data may be obtained while drilling. However, some parameters are unmeasurable using some sonic tools.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

An example method in accordance with the teachings of this disclosure includes estimating a theoretical value of a first input parameter and setting a second input parameter to a known value. The known value is different than an actual value of the second input parameter. The method also includes identifying a frequency band using a processor that minimizes an effect of the second input parameter on a shear slowness inversion value.

Another example method in accordance with the teachings of this disclosure includes estimating theoretical values for shear slowness and drilling fluid slowness and setting a borehole diameter to a drill bit diameter. The borehole diameter is different than the drill bit diameter. The example method also includes identifying a frequency range using a processor that minimizes an effect of the borehole diameter being set to the drill bit diameter on a shear slowness inversion value.

An example apparatus includes one or more sources spaced from a receiver. The one or more sources are to transmit one or more signals and the receiver is to receive at least a portion of the one or more signals. The example apparatus also includes a processor to identify a frequency band to be used to process waveform data. The waveform data is associated with the one or more signals. The frequency band is to minimize an effect of an erroneous input value on a parameter estimate.

### FIGURES

Embodiments of systems and methods for waveform processing are described with reference to the following figures. The same numbers are used throughout the figures to reference like features and components.

FIG. 1 illustrates an example system in which embodiments of the methods and apparatus for waveform processing may be implemented.

FIG. 2 illustrates another example system in which embodiments of the methods and apparatus for waveform processing may be implemented.

FIGS. 3-10 depict processing results using the examples disclosed herein.

FIG. 11 depicts an example process that can be implemented using the example apparatus for waveform processing.

FIG. 12 is a schematic illustration of an example processor platform that may be used and/or programmed to implement any or all of the example methods are apparatus disclosed herein.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

Waveforms obtained from a downhole environment may be processed to obtain a better understanding of the formation. For example, sonic waveforms may be processed to generate dispersion curves and/or identify parameters of the formation and/or parameters used in further processing (e.g., a frequency band, shear slowness, etc.). Some input parameters used in such processing may be unknown and, thus, are estimated and/or fixed. In sonic while drilling applications, the reliability of processing results may decrease when unknown inputs (e.g., input logs) are used in an inversion to generate a model dispersion curve and for selecting a frequency band used to generate the model dispersion curve.

The examples disclosed herein enable a frequency band to be more accurately defined and/or determined when some inputs used in the processing are erroneous. Specifically, the examples disclosed herein minimize the effect of unknown and/or erroneous inputs on inverted shear slowness (DTs) estimates by identifying a frequency band where the input error least affects the inverted shear slowness. In some examples, the borehole diameter input is an erroneous input because some sonic tools do not include a caliper and/or other tool to measure the borehole diameter. Thus, a drill bit diameter and/or bit size is instead used as a fixed input. Because the borehole diameter does not equal the drill bit diameter, the accuracy of processing and/or inversion results may be affected. However, the amount of error introduced into the inversion by the erroneous input depends on the sensitivity of the input parameters to a quadrupole dispersion curve and the effect on a shear slowness estimate. If the sensitivity of an input is large for the model dispersion curve, then the error introduced by estimating and/or fixing the input may be relatively large.

In some examples, to identify this frequency band, error coefficients (α, β) of the shear slowness (DTs) and the mud slowness (DTm) (i.e., drilling fluid slowness) are parameterized by lower and upper wide band frequency limits. By identifying the frequency band that minimizes the sensitivity of the shear slowness error coefficient (a), the effect of the error input is minimized. While the above example describes minimizing error introduced by setting the borehole diameter to the bit size, the examples disclosed herein may be used to minimize any other input error.

In operation, in some examples, to select a frequency range that minimizes shear slowness error caused by setting the borehole diameter to the bit size (i.e., borehole diameter input log error), the borehole diameter is assumed to be the factor that causes error in the inversion and the borehole diameter input error is assumed to be proportional to the shear slowness error and the mud slowness error. In some such examples, the shear slowness error coefficient (a) is determined for a wide frequency band and, using a cost function and/or line fit scheme, the minimum shear slowness error coefficient (a) is identified which corresponds to a frequency range that enables the shear slowness to be accurately estimated.

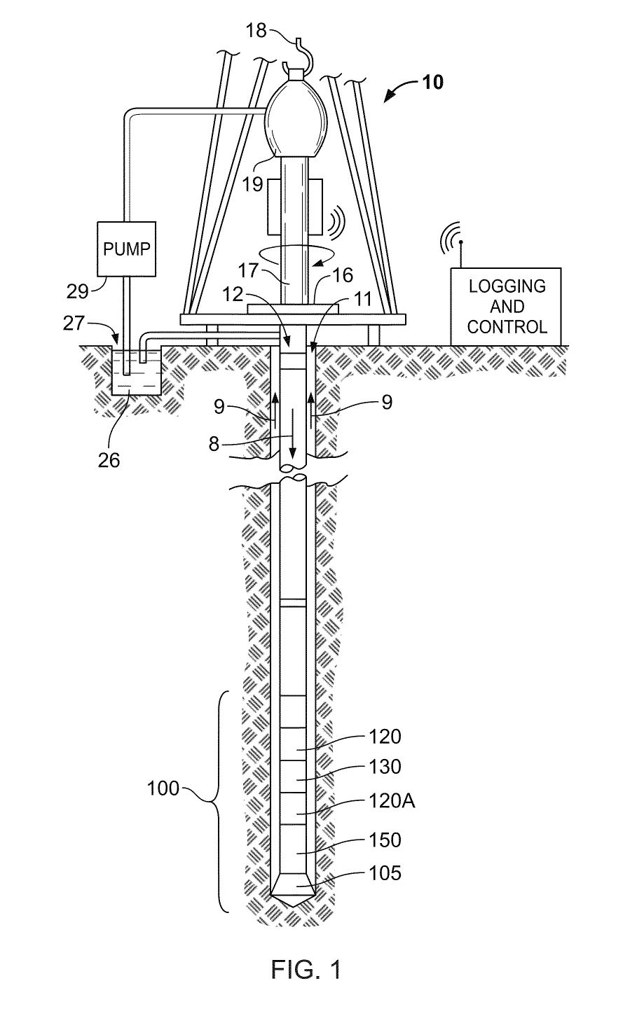

FIG. 1 illustrates a wellsite system in which the examples disclosed herein can be employed. The wellsite can be onshore or offshore. In this example system, a borehole 11 is formed in subsurface formations by rotary drilling. However, the examples described herein can also use directional drilling, as will be described hereinafter.

A drill string 12 is suspended within the borehole 11 and has a bottom hole assembly 100 that includes a drill bit 105 at its lower end. The surface system includes a platform and derrick assembly 10 positioned over the borehole 11. The assembly 10 includes a rotary table 16, a kelly 17, a hook 18 and a rotary swivel 19. The drill string 12 is rotated by the rotary table 16. The rotatory table 16 may be energized by a device or system not shown. The rotary table 16 may engage the kelly 17 at the upper end of the drill string 12. The drill string 12 is suspended from the hook 18, which is attached to a traveling block (also not shown). Additionally, the drill string 12 is positioned through the kelly 17 and the rotary swivel 19, which permits rotation of the drill string 12 relative to the hook 18. Additionally or alternatively, a top drive system may be used to impart rotation to the drill string 12.

In this example, the surface system further includes drilling fluid or mud 26 stored in a pit 27 formed at the well site. A pump 29 delivers the drilling fluid 26 to the interior of the drill string 12 via a port in the swivel 19, causing the drilling fluid 26 to flow downwardly through the drill string 12 as indicated by the directional arrow 8. The drilling fluid 26 exits the drill string 12 via ports in the drill bit 105, and then circulates upwardly through the annulus region between the outside of the drill string 12 and the wall of the borehole 11, as indicated by the directional arrows 9. In this manner, the drilling fluid 26 lubricates the drill bit 105 and carries formation cuttings up to the surface as it is returned to the pit 27 for recirculation.

The bottom hole assembly 100 of the example illustrated in FIG. 1 includes a logging-while-drilling (LWD) module 120, a measuring-while-drilling (MWD) module 130, a roto-steerable system and motor 150, and the drill bit 105.

The LWD module 120 may be housed in a special type of drill collar and can contain one or more logging tools. In some examples, the bottom hole assembly 100 may include additional LWD and/or MWD modules. As such, references throughout this description to reference numeral 120 may additionally or alternatively include 120A. The LWD module 120 may include capabilities for measuring, processing, and storing information, as well as for communicating with the surface equipment. Additionally or alternatively, the LWD module 120 includes a sonic measuring device.

The MWD module 130 may also be housed in a drill collar and can contain one or more devices for measuring characteristics of the drill string 12 and/or drill bit 105. The MWD module 130 further may include an apparatus (not shown) for generating electrical power for at least portions of the bottom hole assembly 100. The apparatus for generating electrical power may include a mud turbine generator powered by the flow of the drilling fluid. However, other power and/or battery systems may be employed. In this example, the MWD module 130 includes one or more of the following types of measuring devices: a weight-on-bit measuring device, a torque measuring device, a vibration measuring device, a shock measuring device, a stick slip measuring device, a direction measuring device and/or an inclination measuring device.

Although the components of FIG. 1 are shown and described as being implemented in a particular conveyance type, the examples disclosed herein are not limited to a particular conveyance type but, instead, may be implemented in connection with different conveyance types include, for example, coiled tubing, wireline wired drillpipe and/or any other conveyance types known in the industry.

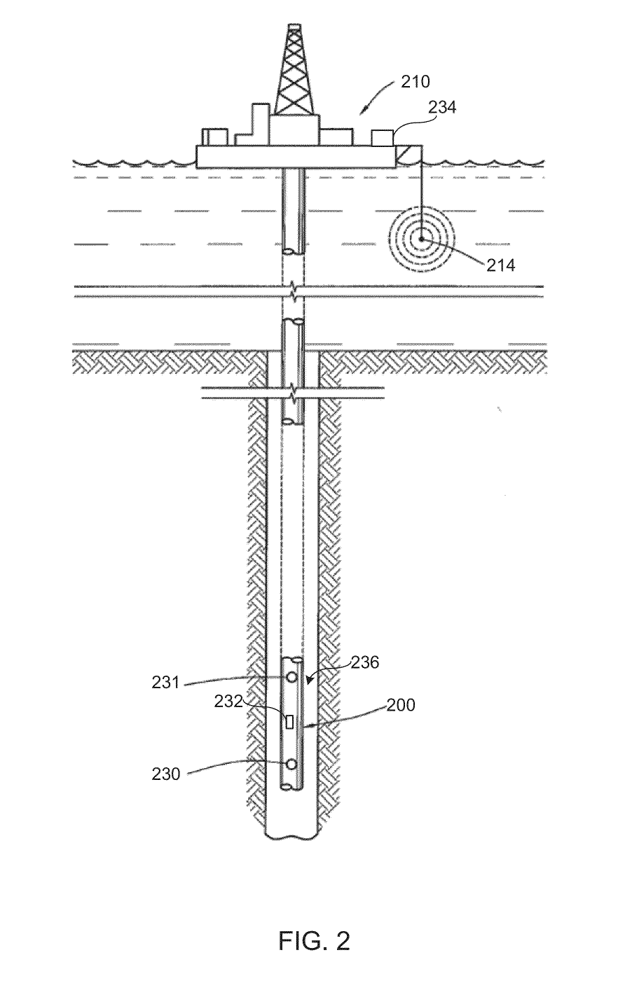

FIG. 2 illustrates a sonic logging-while-drilling tool that can be used to implement the LWD tool 120 or may be a part of an LWD tool suite 120A of the type described in U.S. Pat. No. 6,308,137, which is hereby incorporated herein by reference in its entirety. An offshore rig 210 having a sonic transmitting source or array 214 may be deployed near the surface of the water. Additionally or alternatively, any other type of uphole or downhole source or transmitter may be provided to transmit sonic signals. In some examples, an uphole processor controls the firing of the transmitter 214.

Uphole equipment can also include acoustic receivers (not shown) and a recorder (not shown) for capturing reference signals near the source of the signals (e.g., the transmitter 214). The uphole equipment may also include telemetry equipment (not shown) for receiving MWD signals from the downhole equipment. The telemetry equipment and the recorder are may be coupled to a processor (not shown) so that recordings may be synchronized using uphole and downhole clocks. A downhole LWD module 200 includes at least acoustic receivers 230 and 231, which are coupled to a signal processor so that recordings may be made of signals detected by the receivers in synchronization with the firing of the signal source.

In operation, the transmitter 214 transmits signals and/or waves that are received by one or more of the receivers 230, 231. The received signals may be recorded and/or logged to generate associated waveform data. The waveform data may be processed by processors 232 and/or 234 to obtain quadrupole waveform data, slownesses of arrival and/or slowness dispersions and/or curves. For example, for a homogeneous isotropic (HI) formation and a mandrel structure 236, a model dispersion curve of a quadrupole may be determined using Equation 1. As shown by Equation 1, a model dispersion curve is a function of compressional slowness (DTc), shear slowness (DTs), formation density (Rhob), mud slowness (DTm), mud density (Rhom), borehole diameter (BHD) and frequency (f).

disp=disp(DTc,DTs,Rhob,DTm,R hom,BHD,f) Equation 1

If a difference, δ_{BHD}, between the bit size (BS) and the borehole diameter (BHD) is small enough to be approximated by a first order Taylor expansion, then the model dispersion curve can be represented by Equation 2 below.

$$disp ( DTc , DTs , Rhob , DTm , R hom , BHD , f ) = disp ( DTc , DTs , Rhob , DTm , R hom , BS + δ , f ) \approx disp ( DTc , DTs , Rhob , DTm , R hom , BS , f ) + \frac{\partial disp}{\partial BHD} \times δ \qquad Equation 2$$

When processing a model-based dispersive wave using bit size in the inversion instead of borehole diameter, a difference between the bit size (BS) and the borehole diameter (BHD) may create errors in the shear slowness (DTs) and the mud slowness (DTm). However, the first term on the right hand side of Equation 2^{(disp(DTc,Dts,Rhob,DTm,R hom,BS,f)}) includes no error in the quadrupole inversion even if an erroneous bit size (BS) input is used. Thus, the error introduced to the shear slowness (DTs) and the mud slowness (DTm) by the bit size (BS) may only affect the second term on the right hand side of Equation 2

$$( \frac{\partial disp}{\partial BHD} \times δ ) ,$$

represented by Equation 3. Referring to Equation 3, δ_{DTs} and δ_{DTm} are constant values and ε(f) represents the model error as a function of frequency. In some examples, increasing δ_{DTs}, δ_{DTm} and ε(f) correspondingly increases an error of the shear slowness (DTs) and mud slowness (DTm) and decreases cost function coherence.

$$\frac{\partial disp}{\partial BHD} ( f ) \times {δ}_{BHD} = \frac{\partial disp}{\partial DTs} ( f ) \times {δ}_{DTs} + \frac{\partial disp}{\partial DTm} ( f ) \times {δ}_{DTm} + ɛ ( f ) \qquad Equation 3$$

Equation 4 represents a situation in which δ_{DTs} and δ_{DTm} are relatively small.

$$disp ( DTc , DTs , Rhob , DTm , R hom , BS , f ) + \frac{\partial disp}{\partial BHD} \times {δ}_{BHD} = disp ( DTc , DTs , Rhob , DTm , R hom , BS , f ) + \frac{\partial disp}{\partial DTs} \times {δ}_{DTs} + \frac{\partial disp}{\partial DTm} \times {δ}_{DTm} + ɛ \approx disp ( DTc , DTs + {δ}_{DTs} , Rhob , DTm + {δ}_{DTm} , R hom , BS , f ) + ɛ \qquad Equation 4$$

In some examples, because the shear slowness may be the parameter of interest and/or the parameter being determined, minimizing the error, δ_{DTs}, for the shear slowness (DTs) may be prioritized over minimizing the error, δ_{DTm}, for the mud slowness (DTm).

Equation 5 represents the relationship between the borehole diameter (BHD), the shear slowness (DTs) and the mud slowness (DTm). Because the dispersion curve depends on frequency, the errors δ_{DTs} and δ_{DTm} depend on the frequency band selected (fₗ and fₕ). To decrease the error in the determined shear slowness, the error, |δ_{DTs}|, is minimized as a function of fₗ and fₕ.

$$\frac{\partial disp}{\partial BHD} ( f ) \times {δ}_{BHD} = \frac{\partial disp}{\partial DTs} ( f ) \times {δ}_{DTs} ( {f}_{l} , {f}_{h} ) + \frac{\partial disp}{\partial DTm} ( f ) \times {δ}_{DTm} ( {f}_{l} , {f}_{h} ) + C ( f ) \qquad Equation 5$$

Equation 6 represents Equation 3 rewritten in terms of normalized sensitivity and normalized input error.

S_{BHD}(f)=S_{DTs}(f)×α(fₗ,fₕ)+S_{DTm}(f)×β(fₗ,fₕ)+ε′(f) Equation 6

Equation 7 represents the normalized sensitivity, Sₚ, for parameter, p.

$${S}_{p} = \frac{p}{disp} \frac{\partial disp}{\partial p} \qquad Equation 7$$

Equations 8 and 9 represent normalized error coefficients, α(fₗ, fₕ),β(fₗ, fₕ), which are amplifier factors for the error rate for the shear slowness (DTs) and the mud slowness (DTm), respectively, over the erroneous input rate δ_{BHD}IBS.

$$\begin{matrix}α ( {f}_{l} , {f}_{h} ) = \frac{{δ}_{DTs} ( {f}_{l} , {f}_{h} ) / DTs}{δ / BS} & Equation 8 \\ β ( {f}_{l} , {f}_{h} ) = \frac{{δ}_{DTm} ( {f}_{l} , {f}_{h} ) / DTm}{δ / BS} & Equation 9\end{matrix}$$

Equation 10 represents the model error, ε(f), over δ_{BHD}IBS.

$${ɛ}^{′} ( f ) = \frac{ɛ ( f )}{δ / BS} \qquad Equation 10$$

Because the shear slowness (DTs), the borehole diameter error, δ_{BHD}, and the bit size (BS) are constant, minimizing the shear slowness error, |δ_{DTs}|, is equivalent to minimizing the square of the normalized shear slowness error coefficient, |α|².

In some examples, if model error, ε′(f), is assumed to be free from bias, the normalized shear slowness error coefficient, a, can be estimated by a line and/or curve fit problem by solving Equation 11, where Δf is the frequency step value. The model error, ε(f), and fitting error, err, may be determined using Equations 12 and 13, respectively.

$$\begin{matrix}[ \begin{matrix}{S}_{BHD} ( {f}_{l} ) \\ {S}_{BHD} ( {f}_{l} + Δ f ) \\ ⋮ \\ {S}_{BHD} ( {f}_{h} )\end{matrix} ] = [ \begin{matrix}{S}_{DTs} ( {f}_{l} ) & {S}_{DTm} ( {f}_{l} ) \\ {S}_{DTs} ( {f}_{l} + Δ f ) & {S}_{DTm} ( {f}_{l} + Δ f ) \\ ⋮ & ⋮ \\ {S}_{DTs} ( {f}_{h} ) & {S}_{DTm} ( {f}_{h} )\end{matrix} ] [ \begin{matrix}α \\ β\end{matrix} ] & Equation 11 \\ ɛ ( f ) = {S}_{BHD} ( f ) - {S}_{BHD}^{cal} ( f ) = {S}_{BHD} ( f ) - {S}_{DTs} ( f ) \times α - {S}_{DTm} ( f ) \times β & Equation 12 \\ err = \sqrt{\frac{\sum {ɛ}^{2}}{N - 1}} & Equation 13\end{matrix}$$

In some examples, Equation 11 does not account for spectrum energy effect and a uniform weight factor may be applied to each frequency. However, in some examples, in the semblance computation, the model error, ε(f), is free from bias under the condition of energy distribution, w(f). In some such examples, if the energy distribution, w(f), is given, Equation 11 can be generalized as a linear fitting with weight factor, as shown in Equation 14. As with Equation 11, Equation 14 can be used to estimate the normalized shear slowness error coefficient, α.

$$[ \begin{matrix}w ( {f}_{l} ) & & & 0 \\ & w ( {f}_{l} + Δ f ) & & \\ & & ⋱ & \\ 0 & & & w ( {f}_{h} )\end{matrix} ] [ \begin{matrix}{S}_{BHD} ( {f}_{l} ) \\ {S}_{BHD} ( {f}_{l} + Δ f ) \\ ⋮ \\ {S}_{BHD} ( {f}_{h} )\end{matrix} ] = [ \begin{matrix}w ( {f}_{l} ) & & & 0 \\ & w ( {f}_{l} + Δ f ) & & \\ & & ⋱ & \\ 0 & & & w ( {f}_{h} )\end{matrix} ] [ \begin{matrix}{S}_{DTs} ( {f}_{l} ) & {S}_{DTm} ( {f}_{l} ) \\ {S}_{DTs} ( {f}_{l} + Δ f ) & {S}_{DTm} ( {f}_{l} + Δ f ) \\ ⋮ & ⋮ \\ {S}_{DTs} ( {f}_{h} ) & {S}_{DTm} ( {f}_{h} )\end{matrix} ] [ \begin{matrix}α \\ β\end{matrix} ] \qquad Equation 14$$

After the shear slowness error coefficient, α, is estimated using Equations 11 and/or 14, for example, the frequency band (e.g., optimal frequency band, (fₗ^{best} and fₕ^{best})) that minimizes shear slowness error may be determined by solving the nonlinear programming problem of Equation 15 with the constraints of Equations 16-18, where λ is the minimum width of the frequency band.

Equation 15

minimize |α(fₗ,fₕ)|² (15)
w.r.t.

fₗ+λ<fₕ Equation 16

fₗₘᵢₙ≦fₗ≦fₗₘₐₓ Equation 17

fₕₘᵢₙ≦fₕ≦fₕₘₐₓ Equation 18

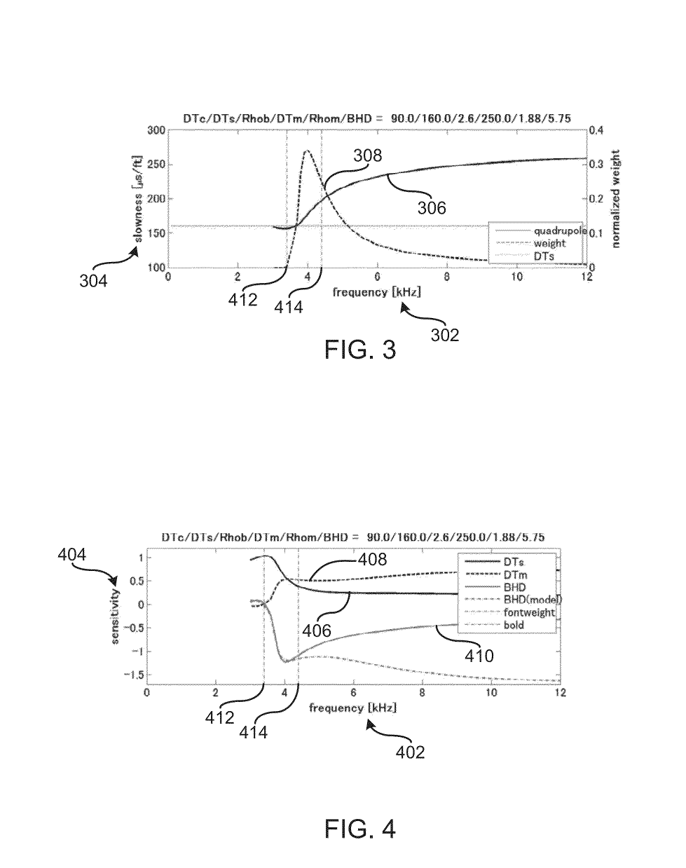

FIGS. 3-10 depict processing results used to identify how the shear slowness error coefficient, α, the mud slowness error coefficient, β, and the fitting error, err, are distributed in the frequency (e.g., (fₗ, fₕ)) domain. FIGS. 3-6, which correspond to a fast formation, were generated using Table 1 below and approximating that the tool structure in the borehole is a concentric mandrel having an outer diameter of 4.75 inches. Additionally, the minimum frequency band width, λ, was set to 1 kilohertz (kHz).

TABLE 1

| | DTc | DTs | Rhob | DTm | Rhom | BHD |
|---|---|---|---|---|---|---|
| Fast | 90 | 160 | 2.6 | 250 | 1.88 | 5.75 |

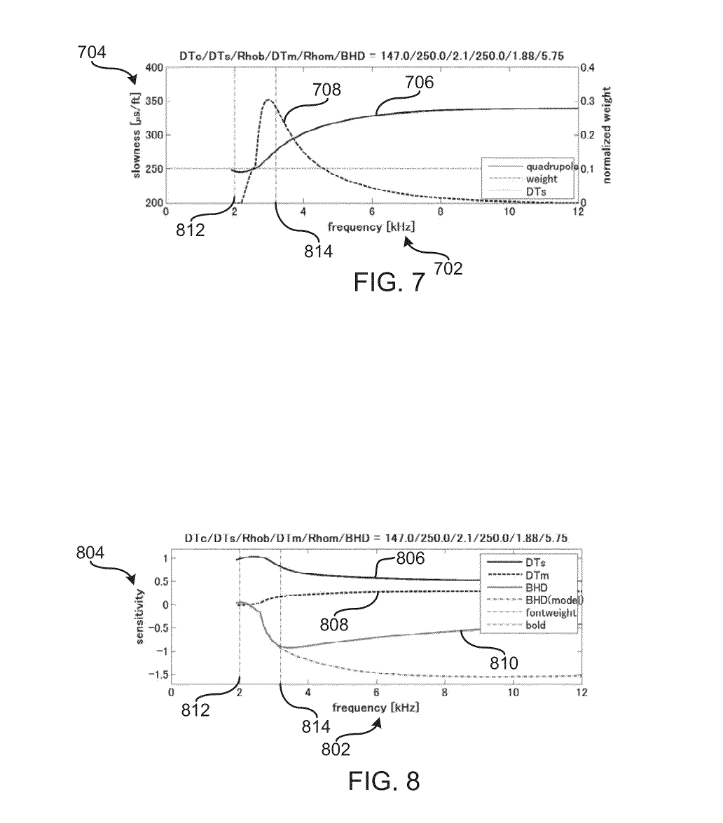

FIGS. 7-10, which correspond to a slow formation, were generated using Table 2 below and approximating that the tool structure in the borehole is a concentric mandrel having an outer diameter of 4.75 inches. Additionally, the minimum frequency band width, λ, was set to 1 kilohertz (kHz).

TABLE 2

| | DTc | DTs | Rhob | DTm | Rhom | BHD |
|---|---|---|---|---|---|---|
| Fast | 90 | 160 | 2.6 | 250 | 1.88 | 5.75 |

Referring to FIGS. 3 and 7, the x-axis 302, 702 corresponds to frequency, the y-axis 304, 704 corresponds to slowness and lines 306, 706 represent a dispersion curve of the quadrupole mode. Lines 308, 708 represent a weight factor that is defined as the first derivative of the quadrupole dispersion curve and normalized such that the weight factor equals one, ∥w∥=l.

Referring to FIGS. 4 and 8, the x-axis 402, 802 corresponds to frequency and the y-axis 404, 804 corresponds to sensitivity. Lines 406, 806 represent sensitivity of the shear slowness at the respective frequencies, lines 408, 808 represent mud slowness at the respective frequencies and lines 410, 810 represent borehole diameter sensitivity at the respective frequencies. For FIGS. 3 and 4, dashed lines 412 and 414 represent the lower and upper frequency band having the smallest shear slowness error coefficient, α. For FIGS. 7 and 8, dashed lines 812 and 814 represent the lower and upper frequency band having the smallest shear slowness error coefficient, α.

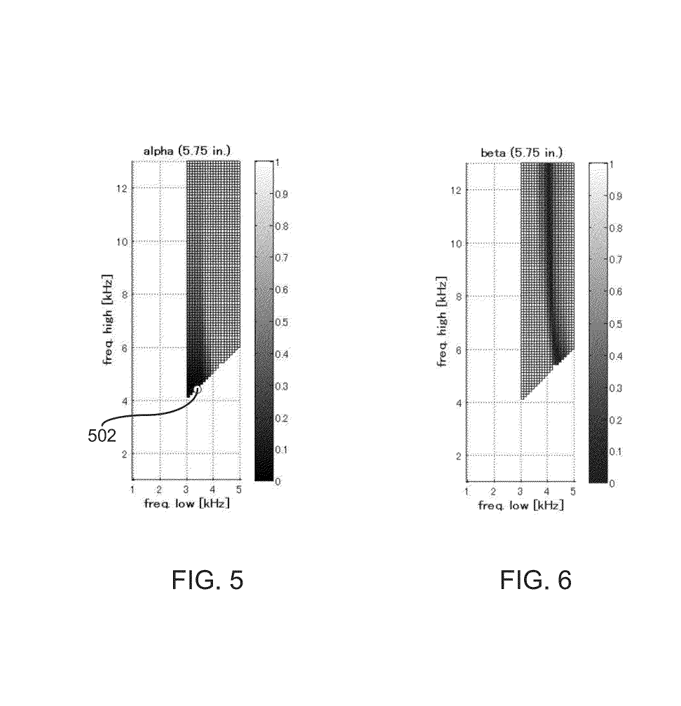

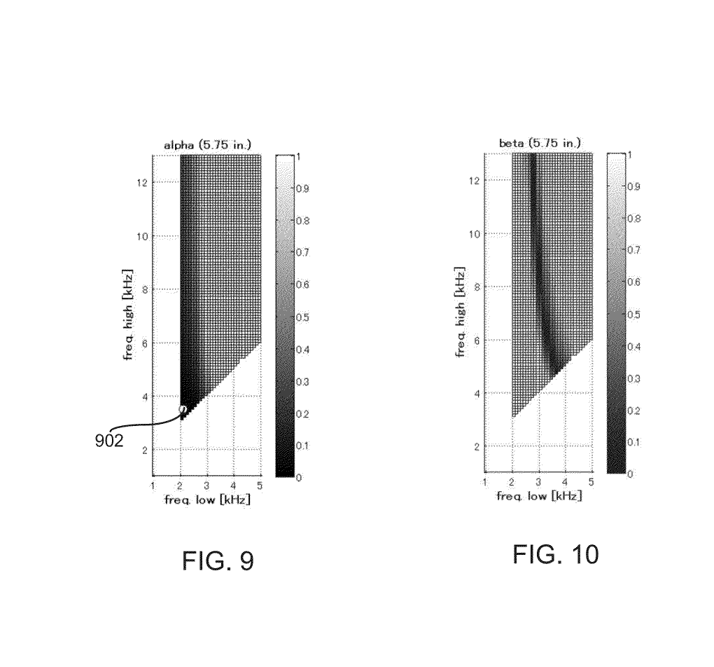

FIGS. 5 and 9 represent the absolute value of the shear slowness error coefficient, α, and the low and high frequencies for the respective values. Reference numbers 502, 902 represent the minimum location of the shear slowness error coefficient. A small shear slowness error coefficient value indicates that the effect of the borehole diameter input error on the mud slowness is maximized and/or the effect of the borehole diameter input error on the shear slowness is minimized. As shown in FIGS. 4 and 8, for the selected frequency range 412, 414, 812, 814 corresponding to the minimum shear slowness error coefficient, the sensitivity of the borehole diameter is substantially similar to the sensitivity of the mud slowness.

FIGS. 6 and 10 represent the absolute value of the mud slowness error coefficient, β.

Table 3 below includes the results using a 0.1 kHz frequency step of the processing results of FIGS. 3-10 using the examples disclosed herein. fₗ is the lower frequency limit where the shear slowness error coefficient is minimized and fₕ is the upper frequency limit where the shear slowness error coefficient is minimized. For both fast and slow formations, the mud slowness error coefficient being negative may indicate that the mud slowness is underestimated when the borehole diameter error, δ_{BHD}, is positive. Thus, as shown in FIGS. 4 and 8, the borehole sensitivity is positive and the mud slowness sensitivity is negative.

The lower limit of the identified frequency, fₗ, corresponds to the cut-off frequency of the quadrupole mode and the upper limit, fₕ, is located at a position greater than the Airy phase (e.g., maximum of the first derivative). For the identified frequency range, if the shear slowness sensitivity is large and the borehole sensitivity is small, the shear slowness may be determined with relatively high accuracy. However, if the shear slowness sensitivity is small and the borehole sensitivity is also small, the system may be unstable and the shear slowness may not be accurately determined, for example.

TABLE 3

| | fₗ | fₕ | α | β | err |
|---|---|---|---|---|---|
| Fast | 3.4 | 4.4 | 0.0070 | −5.2929 | 0.0127 |
| Slow | 2.0 | 3.2 | −0.0015 | −2.2206 | 0.0229 |

Tables 4 and 5 list borehole and processing parameters used for processing and/or computation using a frequency determining module (FDM) for fast and slow formations. In this example, the actual borehole diameter (BHD) was set to 6.0 inches and the bit size (BS) was set to 5.75 inches. Thus, the difference between the bit size and the borehole diameter is 0.25 inches. The processing and/or inversion performed used the bit size instead of the actual borehole diameter.

TABLE 4
(borehole parameters for FDM computation):

| | DTc | DTs | Rhob | DTm | Rhom | BHD |
|---|---|---|---|---|---|---|
| Fast | 90 | 160 | 2.6 | 250 | 1.88 | 6.0 |
| Slow | 147 | 250 | 2.1 | 250 | 1.88 | 6.0 |

TABLE 5
(processing parameters)

| | DTc | Rhob | Rhom | BHD | Unknowns | fₗ(optim) | fₕ(optim) |
|---|---|---|---|---|---|---|---|
| Fast | 90 | 2.6 | 1.88 | 5.75 | DTs, | 3.4 | 4.4 |
| | | | | | DTm | | |
| Slow | 147 | 2.1 | 1.88 | 5.75 | DTs, | 2.0 | 3.2 |
| | | | | | DTm | | |

Table 6 list processing and/or inversion results using the parameters of Tables 4 and 5. The results indicate that shear slowness was estimated with high accuracy while the mud slowness was erroneous, because the frequency band was optimized to minimize the shear slowness error which, in turn, shifted a majority of the borehole diameter input error to the mud slowness.

TABLE 6
(inversion results)

| | DTs | DTm | Coherence |
|---|---|---|---|
| Fast | 160.48 | 225.21 | 0.945 |
| Slow | 249.37 | 217.52 | 0.926 |

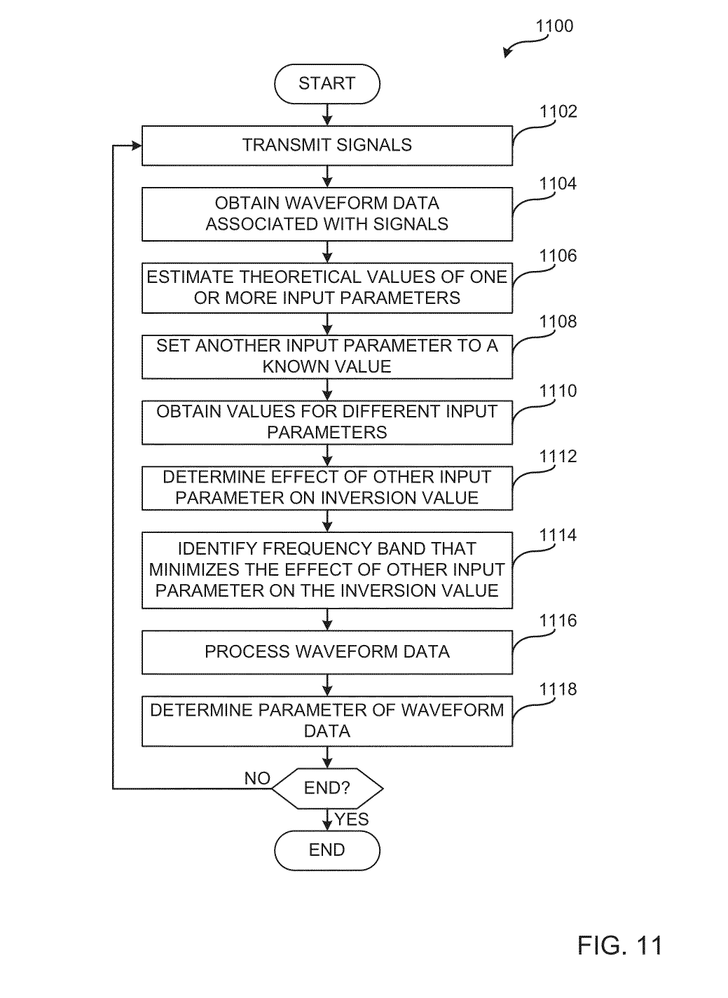

FIG. 11 depicts an example flow diagram representative of processes that may be implemented using, for example, computer readable and executable instructions that may be used to identify an optimal frequency band. The example processes of FIG. 11 may be performed using a processor, a controller and/or any other suitable processing device. For example, the example processes of FIG. 11 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 11 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 11 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 11 may be implemented manually or as any combination(s) of any of the foregoing techniques, for example, any combination of firmware, software, discrete logic and/or hardware. Further, although the example processes of FIG. 11 are described with reference to the flow diagram of FIG. 11, other methods of implementing the processes of FIG. 11 may be employed. For example, the order of execution of the blocks may be changed, and/or some of the blocks described may be changed, eliminated, sub-divided, or combined. Additionally, any or all of the example processes of FIG. 11 may be performed sequentially and/or in parallel by, for example, separate processing threads, processors, devices, discrete logic, circuits, etc.

The example process 1100 of FIG. 11 may begin by transmitting a signal from one or more transmitters and/or sources (block 1102) and receiving the signal at one or more receivers spaced from the transmitters. In some examples, the source may be one or more monopole sources and/or multi-pole sources.

The received signals may be recorded and/or logged to generate waveform data associated with the signals (block 1104). To define a frequency band to be used when processing the waveform data, theoretical values are estimated for one or more input parameters such as shear slowness and/or drilling fluid slowness (block 1106) and another input parameter (e.g., an unmeasured input parameter) is set to a known value (block 1108). In some examples, the other input parameter is the borehole diameter and the known parameter is the drill bit diameter. The drill bit diameter is different than the borehole diameter. At block 1110, values are obtained for different and/or other input values such as compressional slowness, formation density and/or drilling fluid density.

In some examples, the frequency band selected when processing and/or inverting the waveform data is one which minimizes the effect of the erroneous borehole diameter value. To make such a determination, model dispersion curves and/or sensitivity curves may be generated to identify the sensitivity of one or more of the input parameters and determine an effect of the other input parameter (e.g., the borehole diameter value) on an inversion value (block 1112). The inversion value may be a shear slowness inversion value. In some examples, determining the effect on the inversion value includes determining error coefficients of shear slowness and/or drilling fluid slowness for a plurality of frequencies, which are separated by a frequency step.

At block 1114, a frequency band is identified that minimizes the effect of the other input (e.g., the borehole diameter value) on the inversion value (e.g., the shear slowness inversion value). In some examples, identifying the frequency band includes using an optimization algorithm such as the Gauss-Newton method with a penalty function and/or a grid search having a grid interval and/or frequency step. In some examples, identifying the frequency band is associated with minimizing and/or identifying a minimum value of the shear slowness error coefficient and/or maximizing the drilling fluid error coefficient. The waveform data is then processed using the optimal frequency band identified and a parameter such as a shear slowness estimate may be determined (blocks 1116, 1118).

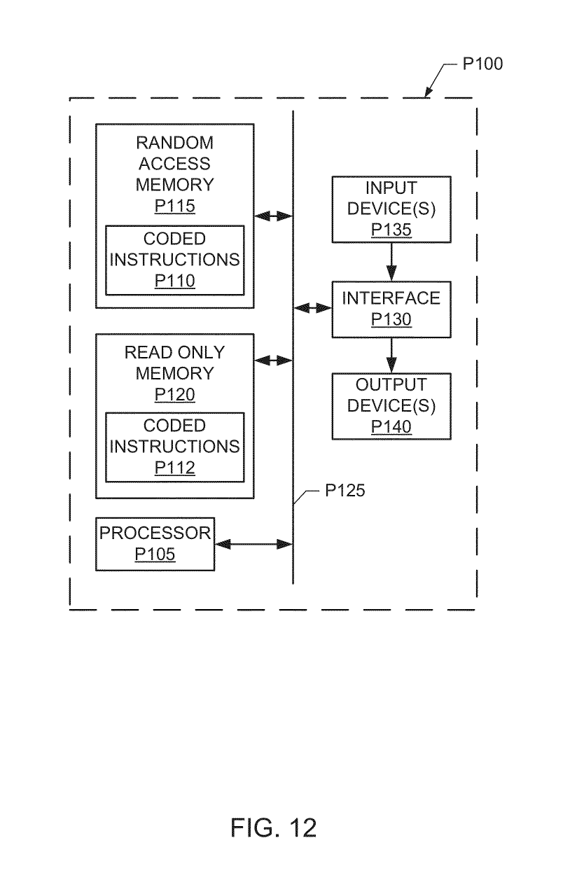

FIG. 12 is a schematic diagram of an example processor platform P100 that may be used and/or programmed to implement to implement a logging and control computer (FIG. 1), the processors 232 and/or 234 and/or any of the examples described herein. For example, the processor platform P100 can be implemented by one or more general purpose processors, processor cores, microcontrollers, etc.

The processor platform P100 of the example of FIG. 12 includes at least one general purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example methods and apparatus described herein.

The processor P105 is in communication with the main memory (including a ROM P120 and/or the RAM P115) via a bus P125. The RAM P115 may be implemented by dynamic random-access memory (DRAM), synchronous dynamic random-access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general purpose input/output, etc. One or more input devices P135 and one or more output devices P140 are connected to the interface circuit P130.

An example method includes estimating a theoretical value of a first input parameter and setting a second input parameter to a known value. The known value is different than an actual value of the second input parameter. The example method also includes identifying a frequency band using a processor that minimizes an effect of the second input parameter on a shear slowness inversion value. In some examples, the method also includes processing waveform data using the frequency band to obtain a shear slowness estimate. In some examples, the second input parameter includes a borehole diameter and the known value includes a drill bit diameter.

In some examples, the method also includes determining a sensitivity of the input parameters to a quadrupole dispersion curve. In some examples, the sensitivity is used to determine the effect of the second input parameter on the shear slowness inversion value. In some examples, the method also includes generating a model dispersion curve to determine the sensitivity of the input parameter. In some examples, the first input parameter is a shear slowness value or a drilling fluid slowness value. In some examples, identifying the frequency range is associated with minimizing a shear slowness error coefficient.

In some examples, the method also includes generating a dispersion curve to identify the frequency band. In some examples, the dispersion curve is generated using one or more of a compressional slowness value, a formation density value, or a drilling fluid density value. In some examples, the method also includes inverting the input parameters using the frequency.

In some examples, the method also includes determining an effect of the second parameter on a shear slowness inversion value. In some examples, determining the effect of the second input parameter on the shear slowness inversion value includes determining a shear slowness error coefficient for a plurality of frequencies. In some examples, the frequencies are separated by a frequency step. In some examples, the frequency band is associated with a minimum value of the shear slowness error coefficient. In some examples, estimating the theoretical value of the input parameter includes estimating the theoretical value of the input parameter for a homogeneous isotropic formation. In some examples, identifying the frequency range is associated with maximizing a drilling fluid slowness error coefficient. In some examples, identifying the frequency band includes performing an optimization technique to identify the frequency band.

Another example method includes estimating theoretical values for shear slowness and drilling fluid slowness and setting a borehole diameter to be drill bit diameter. The borehole diameter is different than the drill bit diameter. The method also includes determining a sensitivity of the shear slowness, the drilling fluid slowness, and borehole diameter over a frequency range. The method also includes, based on determining the sensitivity of one or more of the shear slowness, the drilling fluid slowness, or borehole diameter, identifying a frequency range that minimizes an effect of the borehole diameter being set to the drill bit diameter on a shear slowness inversion value.

A method includes estimating theoretical values for shear slowness and drilling fluid slowness and setting a borehole diameter to a drill bit diameter. The borehole diameter is different than the drill bit diameter. The method also includes identifying a frequency range using a processor that minimizes an effect of the borehole diameter being set to the drill bit diameter on a shear slowness inversion value.

An example apparatus includes one or more sources spaced from a receiver. The one or more sources is to transmit one or more signals and the receiver is to receive at least a portion of the one or more signals. The apparatus also includes a processor to identify a frequency band to be used to process waveform data. The waveform data is associated with the one or more signals. The frequency band is to minimize an effect of an erroneous input value on a parameter estimate. In some examples, the erroneous input value comprises a borehole diameter value. In some examples, the processor is to identify the frequency band by minimizing an error coefficient associated with the parameter estimate. In some examples, the parameter estimate comprises a shear slowness value. In some examples, the processor is to identify the optimal frequency band by minimizing an error coefficient associated with the parameter estimate.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. it is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
estimating a theoretical value of a first input parameter and setting a second input parameter to a known value, the known value being different than an actual value of the second input parameter; and
identifying a frequency band using a processor that minimizes an effect of the second input parameter on a shear slowness inversion value.

2. The method of claim 1, further comprising processing waveform data using the frequency band to obtain a shear slowness estimate.

3. The method of claim 1, wherein the second input parameter comprises a borehole diameter and the known value comprises a drill bit diameter.

4. The method of claim 1, further comprising determining a sensitivity of the input parameters to a quadrupole dispersion curve.

5. The method of claim 4, wherein the sensitivity is used to determine the effect of the second input parameter on the shear slowness inversion value.

6. The method of claim 4, further comprising generating a model dispersion curve to determine the sensitivity of the input parameter.

7. The method of claim 1, wherein the first input parameter comprises a shear slowness value or a drilling fluid slowness value.

8. The method of claim 1, wherein identifying the frequency range is associated with minimizing a shear slowness error coefficient.

9. The method of claim 1, further comprising generating a dispersion curve to identify the frequency band.

10. The method of claim 9, wherein the dispersion curve is generated using one or more of a compressional slowness value, a formation density value, or a drilling fluid density value.

11. The method of claim 1, further comprising inverting the input parameters using the frequency.

12. The method of claim 1, further comprising determining an effect of the second input parameter on a shear slowness inversion value.

13. The method of claim 12, wherein determining the effect of the second input parameter on the shear slowness inversion value comprises determining a shear slowness error coefficient for a plurality of frequencies.

14. The method of claim 13, wherein the frequencies are separated by a frequency step.

15. The method of claim 13, wherein the frequency band is associated with a minimum value of the shear slowness error coefficient.

16. The method of claim 1, wherein estimating the theoretical value of the input parameter comprises estimating the theoretical value of the input parameter for a homogeneous isotropic formation.

17. A method, comprising:
estimating theoretical values for shear slowness and drilling fluid slowness;
setting a borehole diameter to a drill bit diameter, the borehole diameter being different than the drill bit diameter; and
identifying a frequency range using a processor that minimizes an effect of the borehole diameter being set to the drill bit diameter on a shear slowness inversion value.

18. An apparatus, comprising,
one or more sources spaced from a receiver, the one or more sources to transmit one or more signals and the receiver to receive at least a portion of the one or more signals; and
a processor to identify a frequency band to be used to process waveform data, the waveform data associated with the one or more signals, the frequency band to minimize an effect of an erroneous input value on a parameter estimate.

19. The apparatus of claim 18, wherein the erroneous input value comprises a borehole diameter value.

20. The apparatus of claim 18, wherein the processor is to identify the frequency band by minimizing an error coefficient associated with the parameter estimate.
